(19) United States
(12) Patent Application Publication
(10) Pub. No.: US 2009/0307203 A1
(43) Pub. Date: Dec. 10, 2009

(54) METHOD OF LOCATING CONTENT FOR LANGUAGE LEARNING

(76) Inventors: Gregory Keim, Broadway, VA (US); Alisha Huber, Dayton, VA (US); R. Bryce Inouye, Harrionburg, VA (US); Jack Marmorstein, Harrisonburg, VA (US)

Correspondence Address: Kaplan Gilman & Pergament LLP, 1480 Route 9 North, Woodbridge, NJ, 07095, US

(21) Appl. No.: 12/133,031

(22) Filed: Jun. 4, 2008

(51) Int. Cl. G06F 7/06; G06F 17/30

(52) U.S. Cl. 707/5; 707/E17.014

(57) ABSTRACT

A method is disclosed to gather content for use in language learning, the method comprising combining a user entered search phrase with a user model of derived by a language learning program, which user model identifies subject matter that should be learned or practiced. The delivered content then represents topics of interest to a user, and also is optimized to work with the language learning program to teach the target language.

### TECHNICAL FIELD

This invention relates to language learning, and more specifically, to an improved technique of providing a language learner of a target language with content in that target language that represents a close approximation of normal every day content to be encountered by native speakers.

### BACKGROUND OF THE INVENTION

Language teaching methodologies require a user to practice selected sentences and words in order to become fluent in the target language. Language learning software and live courses often spend considerable time and effort compiling the target language content in order for the user to practice newly taught words and phrases.

Prior art techniques of gathering such content in a target language include several drawbacks. Once such drawback is that it is often time consuming and tedious. A second drawback is that the individual gathering such content must pay careful attention to insure that the content is suitable for use by a language learner of a particular level. For example, a user who has been studying a target language for only a few weeks, will have trouble reading or stating orally any content that includes complicated obscure words in the target language, or which includes rare exceptions to grammatical rules, uncommon words, spelling exceptions, etc.

Another such drawback is that a compilation of material in a target language for practice is often done independently of a particular user's interests and/or skill levels. This “one size fits all” approach is less than optimal for almost every language learner.

Still another drawback of prior techniques of gathering content includes the failure to dynamically update such content based upon a user model. Specifically, as the user gets more advanced in the target language, no known techniques exists for easily and rapidly updating the content that he or she may use to practice, on a relatively dynamic, frequent basis.

Moreover, it would be desirable if the target language content used for the language learner to practice were directed specifically to the interests of the language learner. Allowing a language learner to practice words from content directed to his or her own specific interests would likely encourage the language learner to practice more.

In view of the foregoing, there exists a need in the art for a more efficient and customizable manner in which to gather language content and present that content to a user for practicing in a target language.

### BRIEF DESCRIPTION OF THE DRAWINGS

FIG. 1 depicts a flow chart of one exemplary embodiment of the present invention.

### DETAILED DESCRIPTION OF THE PREFERRED EMBODIMENTS

The above drawbacks of the prior art are overcome in accordance with the present invention relating to a manner of gathering, organizing, customizing, and presenting content in a target language for use by a language learner.

In accordance with one example of the invention, a language learner may enter search terms, phrases, or categories into a search engine type of system. The search terms or phrases are optionally translated into a target language, or may be entered by a language learner directly in such target language. A computer search is then performed in accordance with any of plural known techniques.

After the search terms are utilized to retrieve items of information, a previously derived model of the language learner is utilized to filter the results. The previously derived model may include information concerning the user's level of knowledge and other parameters gathered and/or derived by a language learning software program as a result of the language learner's use of the language learning software. Such user model may be imported and used to organize and/or filter the items retrieved by the computer search for presentation to a user.

In another embodiment, the user model from language learning program may be applied to the entered search phrase prior to such search phrase being used to execute a search. Then, the results will be essentially as if the entered search phrase had also included the user model.

In still another embodiment, the search phrase entered by the user is broken up into plural phrases, and each phrase is combined separately with one or more portions (or all) of the user model from the language learning program. Plural searches are then performed, with the results being returned to the user optionally in an order optimized according to parameters derived by the language learning program.

In one exemplary embodiment, a language learner system is employed as exemplified in commonly owned U.S. patent application Ser. No. 12/052,435 (“the '435 application), the contents of which are hereby fully incorporated by reference. As the '435 application indicates, a language learning methodology can establish which particular types of words are known by a particular user, which particular words or phrases should be taught next, etc. The system can also model the user's level of knowledge by ascertaining a percentage that indicates how well a user knows the particular items based upon things like how the user uses tense, voice, timing, speed, and a variety of other factors.

In one embodiment, search results from a search engine type program are processed through a similar user model that indicates how well a user knows certain words in the target language. A predetermined threshold, say 80%, is established as a minimum knowledge requirement for any particular word or phrase.

Once the search results are retrieved, the system can search those documents for occurrences of words that a user knows to at least 80% accuracy, as that knowledge level is defined in the '435 application or otherwise. The system can determine which retrieved items are comprised of at least, say 85%, of words that a user knows to at least 80% accuracy. For terms that do not have at least a predetermined number of occurrences of such words, the system will reject such documents from the retrieved items. The remaining un-rejected items can then be used as the target language content so the user can continue to practice in the target language. The foregoing methodology allows the retrieval of items that are not so far beyond the user's capability in the target language so as to cause frustration.

In another embodiment, a user enters a search phrase or topic into a computer search engine, but the entered phrase is not directly searched. Instead, the language learning program determines a particular set of items that the user should practice learning. The items that the user should practice learning is based upon a variety of factors that govern the language learning curriculum, many of which are described in the incorporated '435 application. Such parameters may include, for example, words previously learned, other words that the language learning program has determined the user needs to practice, etc.

Subsequent to entry of the search phrase by a user, the system would supplement the search query to include terms that the language learning program at issue has determined should be practiced by a user. The search query will then be executed in accordance with conventional techniques, thereby retrieving documents meeting criteria in which the user is interested as well as criteria entered by the language learning program automatically, in order to provide the user with content directed to subject matter in which he is interested, and which properly contains terms and phrases that the language learning program has determined he should practice. The supplementation may also focus upon obtaining items with lots of occurrences of certain types of conjugation, tenses, etc., or any other items the language learning software has determined the user should practice.

More generally, a language learning program ascertains, as part of a fixed curriculum or an iterative process with feedback as described in the '435 application, the specified content for a user to practice in the target language. The user may then enter a search phrase. The search phrase is combined with the specified content for the user to practice. The combination may take place before the search is executed, which would result in the search phrase entered by the user essentially being modified automatically. Alternatively, the search may be executed as entered by the user, with the results being processed by the language learning program after being returned by the search engine. In this case, the results would be further filtered based upon the specified content in the target language that the user should practice.

In another exemplary embodiment, as explained in the '435 application, the system makes determinations as to what words should be taught next in the curriculum, based upon the history and knowledge level of the user. In this embodiment, the search phrase as entered by the user may be used to search a set of items, which are then further processed in accordance with the present invention. Specifically, once the items are retrieved, they can be put through an additional step which attempts to identify items using words that the user should learn next. In this regard, the entered search query can again be modified before the search is done, or the returned results can be processed through an additional search in order to either prioritize by ordering, or completely separate, the returned items so that items that include the words to be taught are presented to a user.

In another embodiment, the entered search phrase is combined with a model of what the user knows, as well as with what the language learning program determines the user should learn next. The combination of all three such sets of words can then be used to perform the search, or one or more of said three sets can be used filter the results of the search after items are returned, as described above. Thus, for example, in this embodiment, the search can be performed to find documents that contain only a small number of occurrences of words that are new to the language learner, which documents are also largely comprised of words with which the user is quite familiar. Preferably, the prescribed number of occurrences of words to be learned by the user would be less than the prescribed number of occurrences of words that are familiar to the user.

Optimally, the returned items can be ordered so that they appear in the order in which the language teaching program determines they should be taught. Specifically, if the program determines that there are 10 words in the next lesson, it may be optimal to teach certain ones of the ten words prior to others. Toward this end, once the items are returned, they can be ordered to ensure that the practice content presented to the user is presented based upon frequency of occurrence of the words to be learned in the proper order. Hence, items with the most occurrences of the words to be learned first can be presented first, wherein items with the most occurrences of words to be learned later can be presented later in the search results.

In still another embodiment, the words to be learned can each be combined separately with the search phrase. In this example, if the language learning software determined that words 1-10 should be taught next, in that order, ten different result sets would be retrieved. The system could combine the first word with the entered search phrase, and the either perform a search based upon that new search criteria, or process the results of the search phrase by using the word to be taught as an additional filter, as previously described. This process can then be separately repeated for each of the remaining 9 words to be taught, each yielding a different result.

It is also noted that the items searched need not be documents, but can be audio objects as well, such as files of speech, video, etc. When audio items are used, the language learning program can also utilize the speed of the speech, numbers of speakers and accent or dialect as additional conditions that can be added to the user's search criteria.

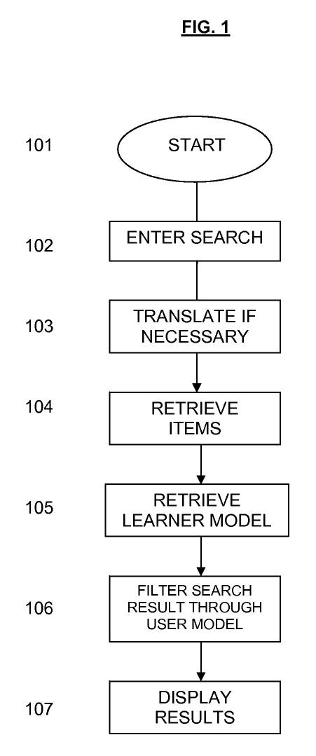

FIG. 1 depicts one exemplary embodiment of a flow chart that implements some of the principles of the present invention described herein. FIG. 1 is only intended to represent some of the basic concepts embodied in the invention, and it is understood that all of the above variations, and others, may be embodied in FIG. 1 as well.

Software is entered at 101 and a search phrase or set of terms is entered by the user at block 102. The search phrase may be entered in the target language, or in the user's native language, as the designer sees fit. After translating the search, if necessary, the search engine may retrieve the items at block 104 and then retrieve a learner model at block 105.

The learner model may include a variety of items indicative of a user's competency in the target language. Such competency may be measured by any of the techniques described in co-pending application '435, or by any other techniques as well.

At block 106, the search results are filtered through an additional step which applies the retrieved learner model in order to either order the search results, or to eliminate from the search results any items that do not also meet the learner model. In addition, the learner model can be applied to the search query itself in order to modify it so that only documents meeting the search criteria and the learner model are retrieved or the learner model can be applied after the search results are retrieved.

In any event, at block 107, the search results are displayed to a user, thereby presenting the user content of interest to the user, and customized based upon the language learner model derived by the language learning software.

It is noted that further variations to the above basic concept are also contemplated hereby. Specifically, the searching can be of any type of audio, video, or any other type of file. One possible methodology of searching these other file types is to process them through an audio to text converter, and then search them as text. Alternatively, audio and/or speech recognition systems can be sued to recognize specifics of any language, so that search engine located content can be further filtered, either before or after a search is executed, in order to focus the results upon various aspects of a target language that a language learning program has identified should be practiced by a language learner.

It is also possible that the search need not be of a full document or item, but that the system could qualify parts of it. For example, a page that has at least three occurrences of a word that needs to be practiced could be retrieved and pass the filter, even if the entire one hundred page document from which it comes includes only the same three occurrences. Such a methodology could work by returning the relevant part of a document, for example, or by returning the whole thing with the pertinent parts highlighted or denoted in some other way.

If an audio or video file also comes with a written transcript (e.g.; closed captioned) then this can be used with the speech recognition to test how well the speech recognition software is recognizing the audio in the audio part of the file.

These and other embodiments are intended to be covered by the following claims, it being understood that the foregoing is exemplary only.

1. A method comprising testing a language learner to identify first items in a target language that said language learner should work on learning, performing a computer search based upon key words entered by said language learner, retrieving second items in response to said computer search, and filtering said second items based upon said first items.

2. The method of claim 1 wherein said step of filtering comprises ordering said retrieved items in an order such that second items in descending order of a number of occurrences of said first items.

3. The method of claim 2 wherein said second items are documents.

4. The method of claim 1 wherein said step of filtering comprises eliminating, from said second items, after said second items are identified, any first items with less than a predetermined number of occurrences of said first items.

5. A method of performing a computer search comprising accepting key terms from a user, supplementing such key terms with first items that a user of a target language should practice, and performing a search based upon said key terms and said first items.

6. The method of claim 5 wherein said key terms are entered in a user's native language.

7. The method of claim 5 wherein said key terms are entered in said target language.

8. A method of practicing a target language comprising modeling a user's skill level, determining phrases that should be practiced, performing a first computer search to identify first items with said phrases, accepting input from a user of keywords directed to topics of a user's interest, and performing a second computer search of said first items to identify first items that are of a user's interest.

9. The method of claim 8 wherein the first computer search is performed automatically and in response to computer program that models said user's skill and determines which phrases should be practiced.

10. A method of assembling content for a language learner comprising performing a search of a set of items in response to user entered search criteria to produce a set of first results, processing said first results to produce a set of second results by determining which portions thereof are in conformance with a prescribed level of language ability, in a target language, demonstrated by said language learner, and presenting said set of second results to said language learner.

11. The method of claim 10 wherein said determining comprises ascertaining at least one of average sentence length and commonality of words used.

12. The method of claim 10 wherein said processing further comprises determining occurrences of words that are intended to be taught by a language learning program but which are ascertained to not have been taught to said language learner, and selecting for presentation items that teach said words that are intended to be taught.

13. The method of claim 10 wherein said items include audio items, and wherein said processing comprises evaluating speed of speech, number of speakers, and accent or dialect.

14. A method of providing language content for a multiuser language learning system comprising having users provide input in textual or audio form in a target language, comparing said input to a model of a language learner of at least one level, ascertaining, in response to said comparison, any portions of said input that failure to meet said model of said language learner of at least one level, and providing a message indicating said failure to meet to a user.

15. The method of claim 15 wherein plural levels are used.

16. The method of claim 15 wherein said any portions are granular to at least a paragraph.

17. A method comprising, performing an analysis of a language learner's skills, and using said analysis in performing a computer search for items entered by a user.

18. The method of claim 18 wherein the user is the language learner.

19. A method comprising accepting computer search criteria, performing a computer search, and classifying results into plural groups, each group corresponding to a level of competence in a language to be learned.

20. The method of claim 19 further comprising ascertaining a level of competence for each of plural groups by testing language learners to form a model of competence for each of plural levels, and then classifying each of said results into the plural levels.

21. A method comprising combining an entered computer search phrase with one or both of words known by a language learner and to be practiced or words to be taught to a language learner, and presenting results of said combination to said language learner.

22. The method of claim 21 where said combination is made by first executing a computer search based upon a phrase entered by a user and then filtering items returned as a result of said search using a user model from a language learning program.

23. The method of claim 21 wherein said combination is made by performing a computer search based a phrase entered by a user combined with a user model from a language learning program, and presenting results of said search to said user.

24. The method of claim 23 wherein said results are further filter based upon said user model prior to being presented to said user.

25. A method comprising accepting a search phrase entered by a user, separately combining said entered search phrase with plural portions of a user model of a language learner, and performing plural searches based upon each of said combinations.

26. The method of claim 25 wherein each portion is represented by a single word.

27. A method comprising providing content for a language learner to practice language by modifying an search phrase entered into a computer with a stored user model of a language learner so that a search actually performed in response to said entered search phrase is not performed based only upon said search phrase, but is instead based upon a combination of said search phrase with portions of said user model.

28. A method comprising providing content for a language learner to practice executing a computer search phrase entered into a computer by a user and then processing results of said computer search using a user model of a language learning program said model identifying portions of said results that meet criteria derived from said user model.

29. The method of claim 28 wherein said criteria is based upon speak, accent, or dialect.

30. The method of claim 10 wherein said items include audio items, and wherein said processing comprises evaluating speed of speech, number of speakers, and accent of dialect.
